(19) United States
(12) Patent Application Publication
(10) Pub. No.: US 2010/0231114 A1
(43) Pub. Date: Sep. 16, 2010

(54) CONDUCTIVE MEMBER, SPACER MADE OF THE CONDUCTIVE MEMBER, AND IMAGE DISPLAY APPARATUS

(75) Inventors: Toru Sato, Ebina-shi (JP); Shingo Eguchi, Hiratsuka-shi (JP); Noriaki Oguri, Zama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/282,378

(22) PCT Filed: Apr. 22, 2008
(86) PCT No.: PCT/JP2008/058232

§ 371 Date: Sep. 10, 2008

(30) Foreign Application Priority Data
Apr. 23, 2007 (JP) 2007-112533
Apr. 1, 2008 (JP) 2008-095107

(51) Int. Cl. H01J 5/00; H01B 1/02

(52) U.S. Cl. 313/317; 252/500; 252/514; 252/512

(57) ABSTRACT

The present invention provides a conductive member that can be produced at low costs and has excellent resistance temperature characteristics, a spacer made of the conductive member, and an image display apparatus using the spacer. More specifically, the conductive member according to the present invention is a conductive member comprising a base material and conductive particles whose conductivity is larger than that of the base material dispersed in the base material, and the conductive particles are dispersed in the base material in such a way that activation energy of the conductive member is 0.3 eV or less and volume resistivity of the conductive member is 10⁵ Ωcm or more.

### TECHNICAL FIELD

The present invention relates to a spacer, which is a construction element of an image display apparatus having an electron-emitting device, a conductive member suitable for the spacer, and an image display apparatus using the conductive member as the spacer.

### BACKGROUND ART

A flat display having an electron-emitting device, as disclosed in Patent Document 1, has an atmosphere pressure-resistance maintenance structure called a spacer or rib to maintain a high vacuum inside thereof.

FIG. 7 is a sectional schematic diagram of an image display apparatus having many electron-emitting devices. In FIG. 7, reference numeral 15 is a rear plate, reference numeral 16 is a side wall, and reference numeral 17 is a face plate. An airtight vessel is formed by the rear plate 15, the side wall 16, and the face plate 17. A spacer 20b, which is an atmosphere pressure-resistance maintenance structure of the airtight vessel, has a low resistance film 70. The low resistance film 70 is connected to a wiring 13 via a conductive flit 78.

An electron-emitting device 12 is formed on the rear plate 15. A phosphor film 18 and a metal back 19 are formed on the face plate 17. The metal back 19 is provided to improve light availability by specular reflection of a portion of light emitted from the phosphor film 18, to protect the phosphor film 18 from collision of anions, and to be used as an electrode for applying a voltage to accelerate an electron beam. The metal back 19 is also provided for use as a conductive path of excited electrons in the phosphor film 18.

FIG. 7 shows a charged state of the spacer. The spacer is charged (FIG. 7: positive charging) by collision of a portion of electrons emitted from an electron source near the spacer. For the sake of convenience of illustration, thickness of the low resistance film 70 of a spacer 20a having no antistatic film 72 is drawn more thickly than that of the low resistance film 70 in contact with the antistatic film 72 of the spacer 20b.

When the spacer 20a is charged positively, electrons emitted from the electron-emitting device 12 serving as an electron source are attracted toward the spacer 20a like an electron orbit 71a. Quality of display images is thereby marred.

To solve this problem, a configuration in which the spacer 20b has the antistatic film 72 is proposed. Accordingly, a minute electric current flows on the surface (the antistatic film 72) of the spacer 20b and thus, electrons charged on the surface of the spacer 20b will be removed. Therefore, electrons emitted from the electron-emitting device draw a predetermined trajectory without being attracted toward the spacer 20b like an electron orbit 71b.

Patent Document 2 discloses, as a technology to effectively suppress charging on the surface of a spacer, a technology to make an effective secondary electron emission coefficient smaller by providing unevenness on the surface of a glass substrate as a spacer than when the surface of the spacer is smooth.

### [Patent Document 1] Japanese Patent Application Laid-Open Publication No. 10-284286

[Patent Document 2] Japanese Patent Application Laid-Open Publication No. 2001-143620 (U.S. Pat. No. 6,494,757)

### DISCLOSURE OF INVENTION

However, if the distribution of temperature in the spacer 20b becomes nonuniform due to a variety of factors, the distribution of resistance of the antistatic film 72 also becomes nonuniform due to resistance temperature characteristics of the antistatic film 72. The distribution of resistance causes fluctuations of a discharging function. In a flat display panel, for example, images near the spacer 20b are disturbed by nonuniform distribution of temperature inside the panel surface. The nonuniform distribution of temperature inside the panel surface is caused by a difference of temperature between the face plate 17 and the rear plate 15.

Further, an antistatic film shown in a conventional example is formed by a film formation method using a vacuum apparatus such as a sputtering method and therefore, it is difficult to reduce manufacturing costs.

An object of the present invention is to provide a conductive member that can be produced at low costs and has excellent resistance temperature characteristics, a spacer made of the conductive member, and an image display apparatus using the spacer.

A first aspect in accordance with the present invention is a conductive member comprising a base material and conductive particles whose conductivity is larger than that of the base material dispersed in the base material,

the conductive particles are dispersed in such a way that activation energy of the conductive member is 0.3 eV or less and volume resistivity of the conductive member is 10⁵ Ωcm or more.

The conductive particles are preferably dispersed in the base material in such a way that Ea (activation energy) of the conductive member is 0.2 eV or less.

The conductive particles are preferably dispersed in such a way that volume resistivity of the conductive member is 10⁸ Ωcm or more.

A particle diameter of the conductive particles preferably is not less than 0.5 nm and not more than 50 μm.

The conductive particles preferably have a volume fraction to the whole conductive member of 50 vol % or less.

The conductive particles are preferably formed of at least one metal selected from gold, platinum, silver, palladium, ruthenium, rhodium, osmium, and iridium.

A second aspect in accordance with the present invention is a spacer arranged between a first substrate and a second substrate in an image display apparatus comprising an airtight vessel having the first substrate having an electron source and the second substrate having an image display member opposite to the electron source, wherein the spacer is the conductive member of the present invention.

A third aspect in accordance with the present invention is an image display apparatus comprising an airtight vessel having a first substrate having an electron source and a second substrate having an image display member opposite to the electron source and a spacer arranged between the first substrate and the second substrate, and the spacer is the conductive member of the present invention.

When a conductive member of the present invention is used as a spacer of an image display apparatus, resistance of the conductive member changes only slightly when the temperature changes and therefore, a disturbance of display images caused by nonuniform distribution of temperature inside an airtight vessel can be controlled to a minimum. In, addition, the conductive member is produced without a vacuum film formation process and thus, can be provided as a low-cost spacer.

A conductive member of the present invention can also be used as a conductive control member used for a developing roller, a transfer roller, a cleaning blade, a cleaning roller, a feed roller or the like in an electrophotographic apparatus such as a copying machine and a printer.

Further features of the present invention will become apparent from the following description of exemplary embodiments with reference to the attached drawings.

### BRIEF DESCRIPTION OF DRAWINGS

FIG. 1A is a diagram exemplifying a conductive member according to the present invention.

FIG. 1B is a schematic diagram showing an observation result of an arbitrary A-A′ section of the conductive member according to the present invention by TEM or SEM.

FIG. 2 is a perspective view showing an example of an image display apparatus according to the present invention by cutting out a portion of a display panel.

FIG. 3 is an Arrhenius plot showing resistance temperature characteristics of the conductive member according to the present invention.

FIG. 4 is a diagram illustrating a beam movement magnitude ΔL developing as a disturbance of image due to an influence of a spacer when there is a difference between a temperature of a face plate and that of a rear plate in the image display apparatus according to the present invention.

FIG. 5 is a diagram illustrating, in the image display apparatus according to the present invention, activation energy Ea of the conductive member and an allowable temperature difference ΔT between the face plate and rear plate of the image display apparatus with respect to a beam movement magnitude perceivable as a disturbance of image.

FIG. 6 is a diagram illustrating a relationship between the particle size of conductive particles and activation energy in the conductive member according to the present invention.

FIG. 7 is a sectional schematic diagram of an image display apparatus having an electron-emitting device for illustrating a mechanism of charging in a spacer according to the present invention.

FIG. 8 is a diagram illustrating the beam movement magnitude ΔL manifesting itself as a disturbance of image due to the influence of the spacer according to the present invention.

FIG. 9 is a diagram showing relationships between a particle size ratio (coarse-particle/fine-particle) during mold filling and a filling ratio in a making process of the conductive member according to the present invention.

FIG. 10 is a table showing evaluation results of a spacer.

### BEST MODE FOR CARRYING OUT THE INVENTION

An object of the present invention is to reduce a disturbance of images near a spacer caused by a difference of temperature between the face plate and rear plate or the like. More specifically, the disturbance of images is caused by nonuniform distribution of temperature in the spacer. As a result of an intensive study, we found that even if a difference of temperature between the face plate and rear plate is controlled, a difference of temperature between the face plate and rear plate of several degrees may partially occur depending on an outside environment such as an installation location of a display apparatus. We also found that even if the temperature of the face plate and that of the rear plate are strictly controlled in a regulated outside environment, the distribution of temperature in the spacer may fluctuate by several degrees depending on an operating state of the display apparatus. Though there is still uncertainty about an exact cause of the phenomenon, we think that the phenomenon is caused in the following manner. When the display apparatus is driving, electrons emitted from an electron-emitting device on the rear plate generate reflected electrons on the face plate. These reflected electrons are irradiated to the spacer. More of these reflected electrons are irradiated to the side of the face plate (face plate side) of the spacer than the side of the rear plate (rear plate side) of the spacer. Also, energy of reflected electrons irradiated to the face plate side of the spacer is larger than that of reflected electrons irradiated to the rear plate side of the spacer. For these reasons, the temperature on the face plate side of the spacer is a little higher than that on the rear plate side of the spacer. Therefore, even if the temperature of the face plate and that of the rear plate are controlled, the distribution of temperature in the spacer fluctuates by several degrees depending on the outside environment and operating environment. Thus, a spacer in which nonuniform distribution of resistance does not occur is demanded even if such nonuniform distribution of temperature occurs. We hit upon the idea of using a conductive member having a plurality of conductive particles dispersed in an insulating base material as a conductive spacer. In the conductive member, electric resistivity caused by temperature changes can be reduced more by controlling activation energy (Ea) and volume resistivity (ρ) in certain electric field intensity and temperatures ranges.

That is, a conductive member according to the present invention is formed by dispersing conductive particles whose conductivity is larger than that of an insulating base material. Conductive particles are dispersed in such a way that Ea of the conductive member is 0.3 eV or less and volume resistivity thereof is 10⁵ Ωcm or more. If a dispersion state of conductive particles is such that Ea of the conductive member exceeds 0.3 eV, electric resistance of the spacer partially fluctuates due to nonuniform distribution of temperature in an airtight vessel caused by a difference of temperature between a first substrate and a second substrate when the conductive member is used as a spacer. Thus, an influence thereof affects the display. If the dispersion state of conductive particles is such that the volume resistivity ρ of the conductive member is less than 10⁵ Ωcm, a thermal runaway may occur due to insufficient electric resistance when the conductive member is used as a spacer. A more suitable dispersion state for a conductive member according to the present invention is one in which Ea of the conductive member is 0.2 eV or less and/or volume resistivity thereof is 10⁸ Ωcm or more.

### (Manufacturing Method of a Conductive Member)

### (1) Preparation of Powder

First, powder of an insulating base material and that of conductive particles are each prepared. A powder manufacturing means is not particularly limited. Such powder is obtained by a physical method such as a crusher, a laser type fine-particle manufacturing machine, and an induction heating fine-particle manufacturing machine, or a chemical method such as an aerosol atomization method and a thermal decomposition method. Such powder is classified by a sieve, a dry classifier, a wet classifier or the like to obtain a desired particle size.

### (2) Mixing

Powder of the base material and that of conductive particles are measured by various composition ratios and then mixed. For example, powder of glass and that of gold particles are mixed. A mixing means is not particularly limited. Such powder is mixed, for example, by a ball mill. Mixing of such powder performs in a non-oxidation atmosphere such as a nitrogen gas and an Ar gas.

### (3) Pre-Sintering

The mixed powder is pre-sintered in an inert gas such as a nitrogen gas and an Ar gas atmosphere, or in a vacuum. The mixed powder may also be pre-sintered in a reduction atmosphere such as hydrogen gas. The temperature of pre-sintering is suitably 800° C. or more and 1500° C. or less.

### (4) Crushing

A mixed solid body generated by pre-sintering is crushed. A crushing means is not particularly limited. For example, the mixed solid body is crushed by a ball mill. Crushing of the mixed solid body performs in a non-oxidation atmosphere such as a nitrogen gas and an Ar gas. Mixed powder obtained after the mixed solid body being crushed is classified by a sieve, a dry classifier, a wet classifier or the like to obtain powder of a required particle size. Here, powder whose particle size is large is called a coarse particle and that whose particle size is small is called a fine particle.

### (5) Vibration Filling

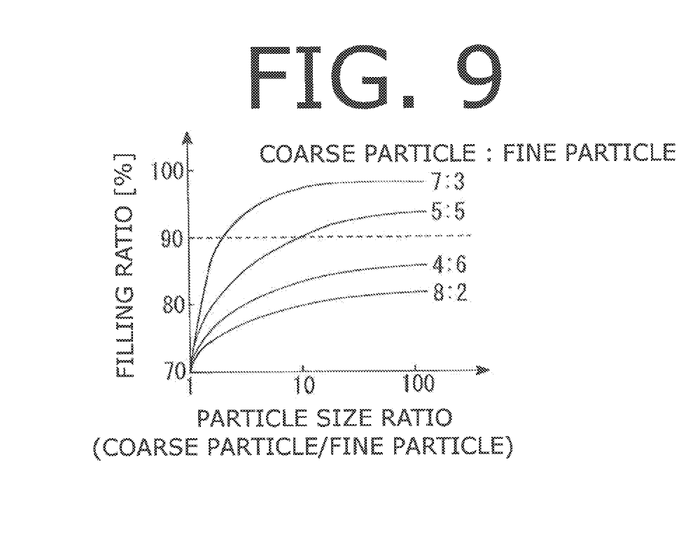

The mixed powder obtained in the crushing process is filled into a mold in an inert gas atmosphere such as a nitrogen gas and an Ar gas, or in a vacuum. A plurality of particles (coarse particles and fine particles) having different particle sizes obtained by classification is selected and the particles (coarse particles and fine particles) are filled by various compounding ratios (mass ratios). Compaction is performed by providing vibration to the mold so that fine particles having a smaller particle size are flow into voids formed by among coarse particles having a larger particle size. FIG. 9 shows relationships between the particle size ratio (coarse-particle/fine-particle) and the filling ratio for each of cases when the mass ratios of coarse particles and fine particles are: coarse-particle: fine-particle=4:6, 5:5, 7:3, and 8:2. The suitable compounding ratio of coarse particles and fine particles to enhance the filling ratio is 5:5 to 7:3 (coarse-particle: fine-particle). If the compounding ratio is unbalanced, mobility of particles is blocked and thus, voids among particles cannot be filled.

If the particle size ratio of coarse particles and fine particles increases, the distribution of coarse particles and fine particles is unbalanced by vibration filling. Thus, uniform dispersion of conductive particles is blocked. Therefore, the particle size ratio of coarse particles and fine particles in mixed powder is suitably 100 or less. The particle size ratio is preferably 10≦particle size ratio≦20. When the compounding ratio of coarse particles and fine particles in mixed powder is: coarse-particle: fine-particle=5:5 or more and 7:3 or less and the particle size ratio≧10, we obtained the filling ratio≧90%. The filling ratio can be improved by controlling the compounding ratio and particle size ratio in mixed powder. Further, conductive particles can uniformly be dispersed.

### (6) Sintering

A sintered body is obtained by pressure-sintering mixed powder filled into the mold, in an inert gas atmosphere such as a nitrogen gas and an Ar gas, or in a vacuum. The mixed powder may also be pressure-sintered in a reduction atmosphere such as hydrogen gas. Hot pressing is preferably used for pressure sintering. By controlling the pressure and temperature, the filling ratio can further be improved to reduce voids remaining among particles. If voids of the same volume remain, conductive particles are dispersed more uniformly when small voids are present in a dispersed manner than large voids are sparsely present. Mixed powder is formed into a predetermined thickness or shape, and sintering is preferably performed under conditions of pressure of 1 MPa or more and 2 MPa or less and temperature of 800° C. or more and 1500° C. or less. The mixed powder is thereby made a conductive member.

To form the conductive member obtained in this manner into a predetermined shape, cutting work is done to the conductive member when appropriate. The conductive member is thereby made a spacer of an image display apparatus according to the present invention. The shape of the spacer is not limited to a tabular shape (plate like shape). The shape of the spacer may also be cruciform, L-shaped, columnar, or an electron beam passage portion having a hole.

If it is an insulation-related member, for a base material of a conductive member, the material in particular is not limited. For example, glass is preferably used as the base material. Conductive particles whose electrical conductivity is higher than that of the base material may be used as the conductive particles of the present invention. At least one metal selected, for example, from gold, platinum, silver, palladium, ruthenium, rhodium, osmium, and iridium is preferably used as a material of the conductive particles.

### (Configuration of a Display Panel)

FIG. 2 is a perspective view of a display panel in an image display apparatus according to the present invention. FIG. 2 shows the display panel by cutting out a portion thereof to show an internal structure of the display panel.

In FIG. 2, reference numeral 15 is a rear plate, reference numeral 16 is a side wall, and reference numeral 17 is a face plate. An airtight vessel to maintain a vacuum of an inner part of the display panel is formed by the rear plate 15, the side wall 16, and the face plate 17. The first substrate and second substrate according to the present invention correspond each to the rear plate or the face plate.

The rear plate 15 and the face plate 17 are arranged facing each other. A fluorescent screen 18 as an image display member is attached to the face plate 17. When assembling an airtight vessel, joint parts of each member need to have sufficient strength and airtightness. For this purpose, such joint parts need to be sealed. Sealing is performed, for example, by applying frit glass to a joint part and then, sintering the frit glass at 400° C. or more and 500° C. or less for 10 minutes or longer in the atmosphere or in a nitrogen atmosphere. A method of evacuating the airtight vessel to a vacuum will be described later.

The inner part of the airtight vessel is maintained in a vacuum of about 10⁻⁴ [Pa]. Thus, a spacer 20 is provided inside the display panel as an atmosphere pressure-resistance maintenance structure to prevent breakdown of the airtight vessel due, for example, to the atmosphere pressure or an unexpected impact. The aforementioned conductive member having an insulating base material and conductive particles dispersed in the base material is used as the spacer 20. The dispersion state of the conductive particles in the base material is controlled in such a way that Ea of the conductive member is 0.3 eV or less and volume resistivity thereof is 10⁵ Ωcm or more.

A substrate 11 is fixed to the rear plate 15. N×M surface conduction electron-emitting devices 12 are formed on the substrate 11. N and M are positive integers equal to or greater than 2. N and M are appropriately set in accordance with the intended number of display pixels. For example, in a display apparatus intended for high-definition TV display, it is preferable to set numbers of N=3000 and M=1000 or more. In the present embodiment, N=3072 and N=1024 are set.

The N×M surface conduction electron-emitting devices 12 are wired as a simple matrix type by connecting M row wiring 13 and N column wiring 14. A portion configured by the substrate 11, the electron-emitting devices 12, the row wiring 13, and the column wiring 14 is called an electron source substrate.

The phosphor film 18 is formed on the underside of the face plate 17. The phosphor film 18 has a metal back 19, which is known in the field of CRT, provided on the surface on the side of the rear plate 15.

Dx1 to Dxm, Dy1 to Dyn, and Hv are terminals for electric connection having an airtight structure to electrically connecting the display panel and an electric circuit (not shown).

Dx1 to Dxm are electrically connected to the row wiring 13 of the surface conduction electron-emitting devices. Dy1 to Dyn are electrically connected to the column wiring 14 of the electron-emitting devices 12. Hv is electrically connected to the metal back 19 of the face plate 17.

After assembling the airtight vessel, an exhaust pipe (not shown) and a vacuum pump are connected. Then, the inner part of the airtight vessel is evacuated to a vacuum by evacuating the airtight vessel using the vacuum pump to a vacuum of 10⁻⁵ [Pa] or less. Subsequently, the exhaust pipe is sealed. At this point, a getter film (not shown) is formed at a predetermined position inside the airtight vessel immediately before or after sealing in order to maintain the degree of vacuum inside the airtight vessel. For example, the getter film is a film evaporated and formed at the predetermined position by heating a getter material containing Ba as a main component by using a heater or through high-frequency heating. The inner part of the airtight vessel is maintained at the degree of vacuum 1×10⁻³ Pa or more and 1×10⁻⁵ Pa or less by adsorbing action of the getter film.

In an image display apparatus using the above-described display panel, a voltage is applied to each of the electron-emitting devices 12 via the ex-vessel terminals Dx1 to Dxm and Dy1 to Dyn. Electrons are thereby emitted from each of the electron-emitting devices 12. The emitted electrons are accelerated by applying a high voltage of several hundred V to several kV to the metal back 19 via the ex-vessel terminal Hv. Then the emitted electrons before being caused to collide against an inner surface of the face plate 17. The phosphor of each color in the phosphor film 18 is excited by collision of an electron beam. Accordingly, the phosphor of each color in the phosphor film 18 emits light. Thereby, an image is displayed.

Generally, the voltage applied to the electron-emitting devices 12 is about 12 to 16 [V]. A distance d between the metal back 19 and the electron-emitting devices 12 is about 0.1 to 8 [mm]. The voltage between the metal back 19 and the electron-emitting devices 12 is about 0.1 to 12 [kV].

### (Evaluation Method of Spacer: Laying Down Criteria by a Sensory Evaluation)

An evaluation method when a conductive member according to the present invention is used as a spacer of an image display apparatus will be described.

If the discharging function of the spacer 20 is insufficient, as shown in FIG. 8, the orbit of the electron beam is disturbed. Thereby, positions of lighting pixels, which should be displayed at equal intervals is moved. It is assumed that an interval L of an original beam position 82 is 1 L and a movement magnitude, which is a difference between a beam position 83 when the electron beam moves due to the spacer and 1 L is ΔL.

50 subjects of adult men and women participated in a visual display image evaluation from a position 1 m apart from the panel surface of a display apparatus installed in a sufficiently bright room.

Disturbances of images due to beam movement was rated on a scale of 3, “not visible”, “visible, but not disturbing”, and “visible and disturbing” to determine a relationship between the evaluation and the beam movement magnitude ΔL.

When the movement magnitude ΔL is 0 or more and 0.01 L or less, the majority of subjects responded with “not visible”.

When the movement magnitude ΔL is more than 0.01 L and is 0.03 L or less, the majority of subjects responded with “visible, but not disturbing”.

When the movement magnitude ΔL is more than 0.03 L, the majority of subjects responded with “visible”.

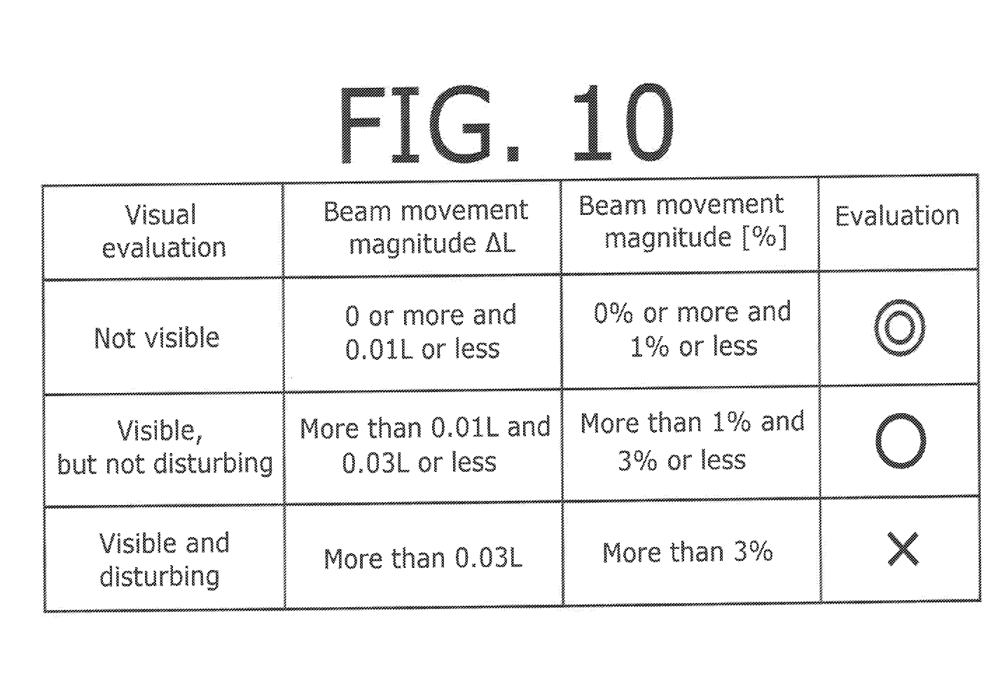

In other words, when the beam movement magnitude exceeds 0.03 L, the number of subjects who perceive distortion of images (feeling of disturbance) rapidly increases and thus, whether an image is good or not can be determined whether the beam movement magnitude exceeds 0.03 L. FIG. 10 shows evaluation results.

Based on the above sensory evaluation results, a performance evaluation of the conductive member according to the present invention was performed. That is, an image evaluation was performed by mounting the conductive member in an image apparatus as a spacer and measuring the beam movement magnitude ΔL by the influence of the spacer.

A transparent film heater is attached to an outside surface of each of the rear plate 15 and the face plate 17 of the image display apparatus. A difference of temperature between the face plate 17 and the rear plate 15 is caused by adjusting electric power provided to the transparent film heater attached to the rear plate 15 and that attached to the face plate 17 respectively. When the temperature stabilizes with the passage of a sufficient time, the spacer 20 can be considered to have nonuniform distribution of temperature due to the difference of temperature between the face plate 17 and the rear plate 15. When the spacer 20 has nonuniform distribution of temperature, the conductive member also has nonuniform distribution of resistance due to resistance temperature characteristics of the conductive member. The distribution of resistance manifests itself as fluctuations of the discharging function, leading to a disturbance of images near the spacer 20.

### (Resistance Temperature Characteristics Evaluation Index Ea: Activation Energy)

Resistance temperature characteristics of the conductive member were measured by changing the temperature of the conductive member while applying a predetermined electric field to the conductive member. An Arrhenius plot of measurement results was created to determine Ea: activation energy from Formula (1)

ρ=A·exp(Ea/kT) (1)

ρ: Volume resistivity [Ωcm]

A: Constant

Ea: Activation energy [eV]

k: Boltzmann constant (1.381×10⁻²³ [JK⁻¹])

T: Temperature [K]

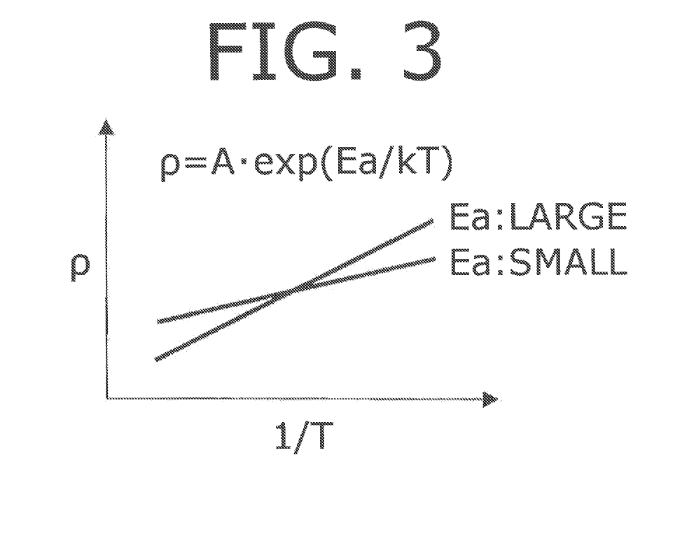

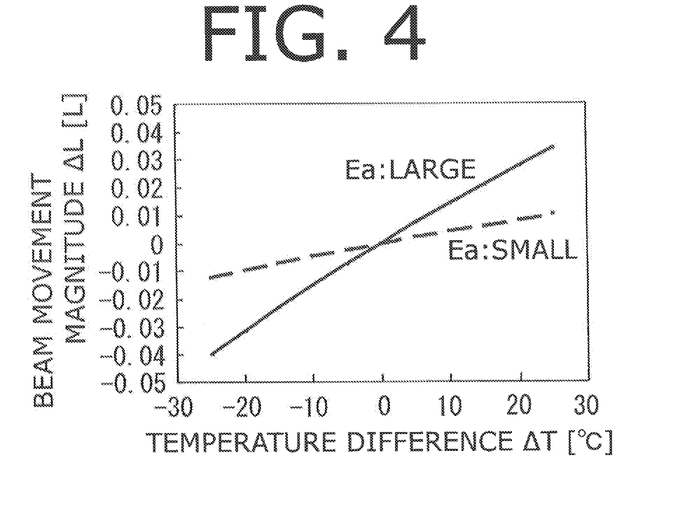

Resistance temperature characteristics of a conductive member according to the present invention will be described using the Arrhenius plot (1). Ea is used as an index of the quality of resistance temperature characteristics. FIG. 3 shows an Arrhenius plot of resistance temperature characteristics of a conductive member. It is evident from FIG. 3 that a conductive member whose Ea is small has excellent resistance temperature characteristics that a resistance change with respect to a temperature change is small.

### (Beam Movement Magnitude and Allowable Temperature Difference)

The discharging function of a conductive member according to the present invention was evaluated by image evaluation such as mounting the conductive member in an image display apparatus as a spacer and measuring the beam movement magnitude ΔL by the influence of the spacer.

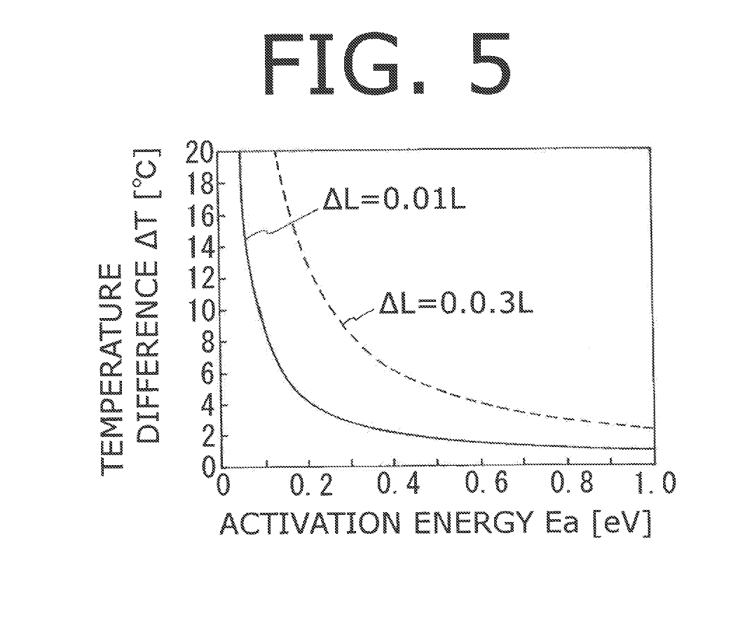

The image display apparatus was installed in a dark room and a difference of temperature between the face plate and the rear plate was caused. Then, a CCD camera was installed at a location a predetermined distance apart from the panel surface to capture a display image. The beam movement magnitude ΔL by the influence of the spacer was determined by calculating the beam position based on the captured image. The beam movement magnitude ΔL due to a temperature difference ΔT can be controlled to a minimum when a conductive member whose Ea is small is used as a spacer. FIG. 4 shows results thereof.

### (Allowable Temperature Difference and Activation Energy Ea)

An image is displayed in an image display apparatus by causing an electron beam emitted from an electron-emitting device provided on the rear plate to collide against a phosphor film provided on the face plate. Thus, a difference of temperature between the face plate and rear plate is caused depending on display images and driving conditions. The difference of temperature results in temperature distribution in the spacer, which is made of a conductive member. Then, nonuniform distribution of resistance is created by resistance temperature characteristics of the conductive member. The distribution of resistance manifests itself as fluctuations of the discharging function, leading to a disturbance of images near the spacer.

FIG. 5 shows a relationship between the allowable temperature difference between the face plate and rear plate and activation energy Ea for the movement magnitude ΔL≦0.01 L when determined to be “not visible” in the sensory evaluation, and that between the allowable temperature difference between the face plate and rear plate and activation energy Ea for the movement magnitude ΔL≦0.03 L when determined to be “visible, but not disturbing” in the sensory evaluation.

A case when a spacer produced by using a conductive member of Ea: 0.3 eV is mounted in an image display apparatus will be described. When the temperature difference between the face plate and rear plate is 3° C., the beam movement magnitude ΔL is 0.01 L or less and thus, a disturbance of image is “not visible”. When the temperature difference between the face plate and rear plate is 8° C., the beam movement magnitude ΔL is 0.03 L or less and thus, a disturbance of image is “visible, but not disturbing”. When the temperature difference between the face plate and rear plate exceeds 8° C., the beam movement magnitude ΔL exceeds 0.03 L and thus, a disturbance of image is “visible”. That is, this result means that images are not disturbed if Ea≦0.3 eV even if temperature distribution of several degrees occurs in the spacer. However, if the volume resistivity ρ of the spacer is less than 10⁵ Ωcm, a large current flows in the spacer even if Ea≦0.3 eV. Accordingly, the temperature of the whole spacer rises, leading to reduced resistance of the spacer. Thus, a so-called a thermal runaway may occur. In this case, there arises a problem that operations of the display apparatus become instable. Thus, the spacer needs to have the volume resistivity ρ of 10⁵ Ωcm or more and the activation energy Ea of 0.3 eV or less.

### (Particle Size of Conductive Particles Contained in the Conductive Member and Activation Energy)

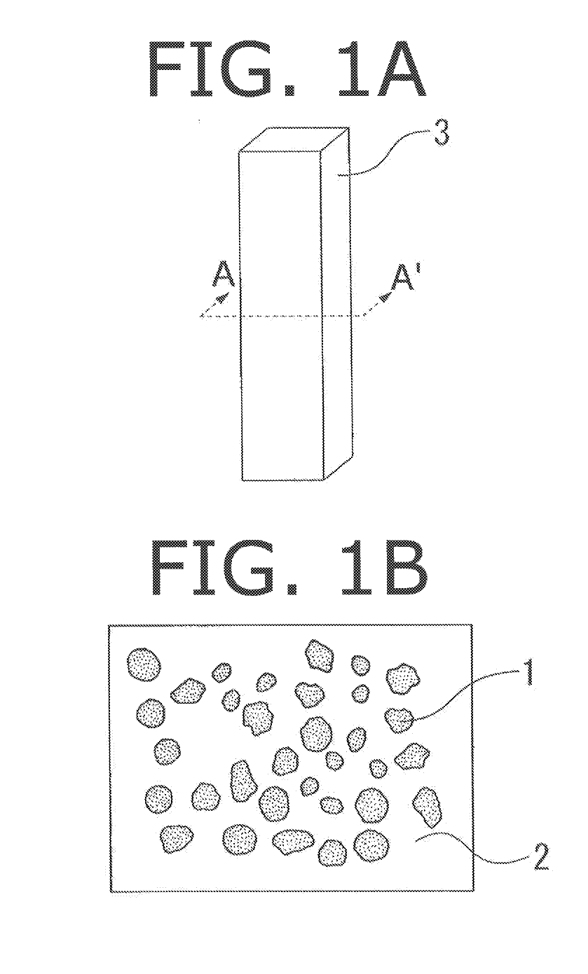

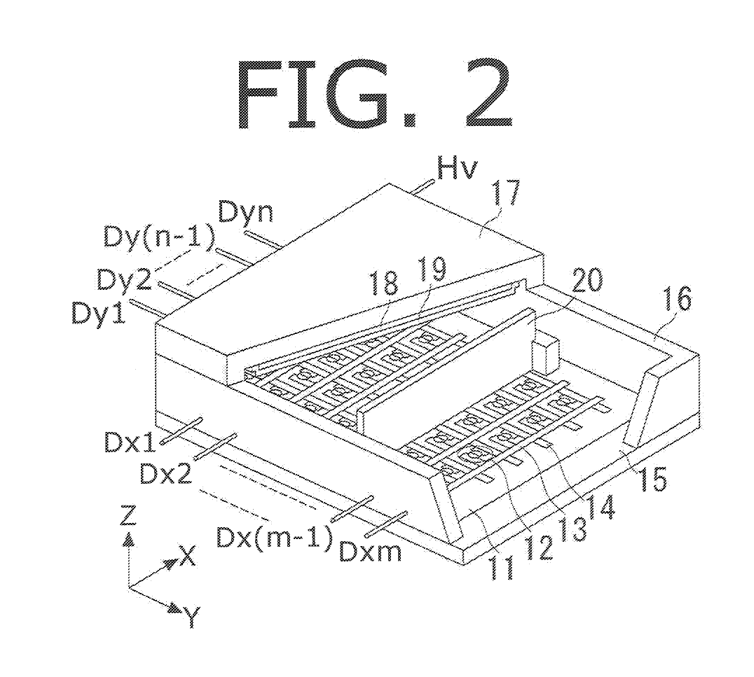

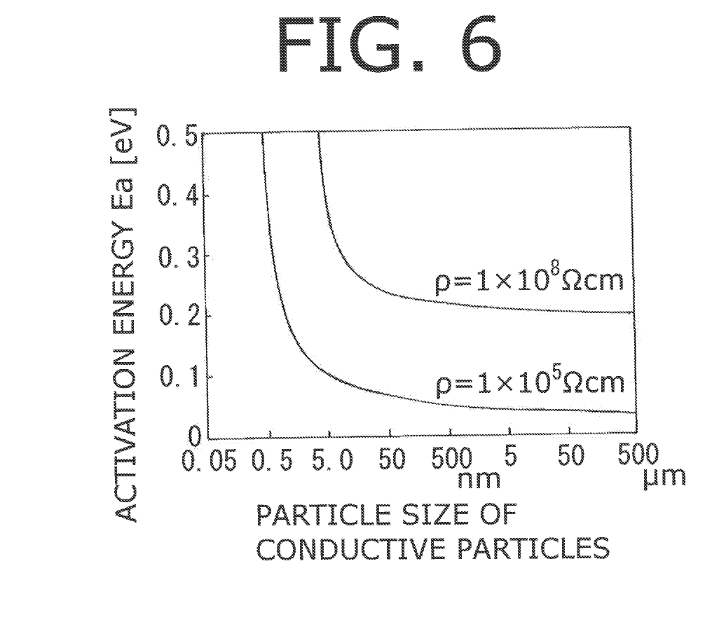

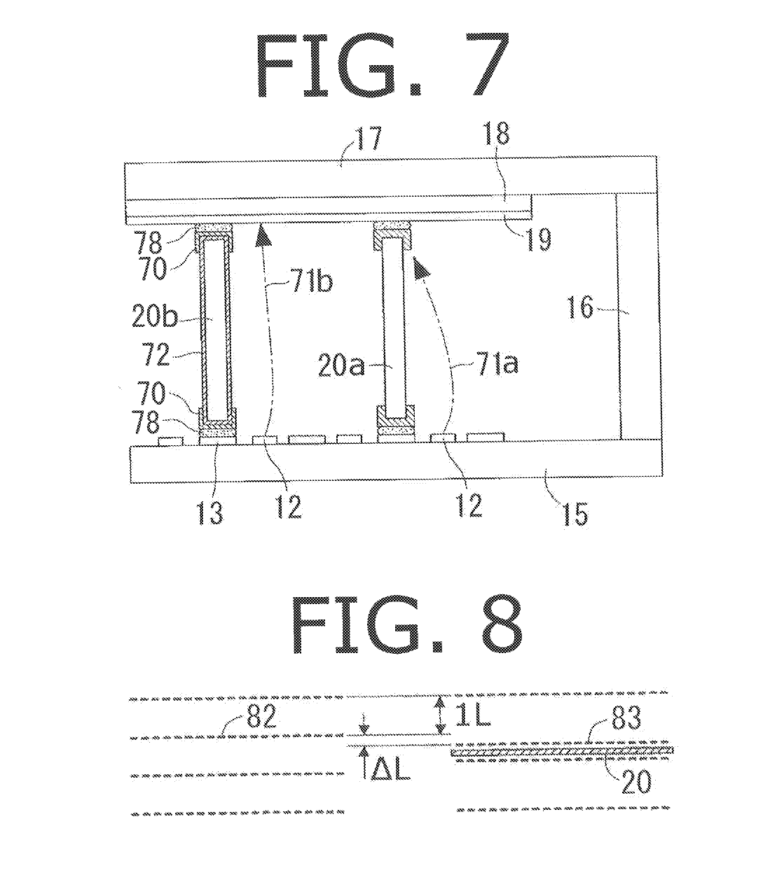

An arbitrary A-A′ section of a conductive member 3 shown in FIG. 1A was observed by a TEM (transmission electron microscope) or a SEM (scanning electron microscope). As shown in FIG. 1B, which is a schematic diagram, the conductive member 3 has a structure in which a plurality of conductive particles 1 having an average particle size (particle diameter) of 0.5 nm or more and 50 μm or less is dispersed in a base material 2. Here, the average particle size is an average value of particle size of 20 conductive particles that obtained from an observation result of a section as shown in FIG. 1B. FIG. 6 shows a relationship between the particle size of conductive particles contained in the conductive member and activation energy (Ea).

If the average particle size is 0.5 nm or more, preferably 1 nm or more, it is easy to satisfy Ea≦0.3 eV. That is, if the average particle size takes a value described above, a conductive member having excellent resistance temperature characteristics that resistance changes only slightly when the temperature changes can be produced. The ratio of conductive particles to the whole conductive member is preferably 50 vol % in terms of volume fraction. If the volume fraction exceeds 50 vol %, it is difficult to increase the volume resistivity ρ of the conductive member to 10⁵ Ωcm or more. By using a conductive member whose volume fraction is 50 vol % or less as a spacer in an image display apparatus, a disturbance of images caused by the spacer can be made smaller.

### Example 1

Gold particles having the particle size of 0.5 nm were prepared as powder of conductive particles. Glass powder (volume resistivity=10¹⁴ Ωcm) having the particle size of 50 μm was prepared as an insulating base material. After the gold particles and glass powder was mixed so that the volume fraction of the gold particles with respect to the whole conductive member became 45 vol %, the mixture was pre-sintered by heating the mixture at 800° C. Mixed powder was produced by crushing a mixed solid body obtained after the pre-sintering. By classifying the mixed powder, mixed powder called coarse particles whose particle size is 500 μm and that called fine particles whose particle size is 50 μm were obtained. The particle size ratio of coarse particles to fine particles was set to 10. Coarse particles and fine particles were compounded in the mass ratio of 7:3 and the compounded mixed powder was filled into a mold while providing vibration. A conductive member was produced by sintering the mold in an Ar gas atmosphere under pressure of 2 MPa at 800° C. The filling ratio of the conductive member was 96%.

The average particle size of gold particles dispersed in the conductive member was determined by using a TEM or SEM. The average particle size of gold particles was 0.5 nm.

Volume resistivity of the conductive member was measured by applying a predetermined electric field (1000 V/mm) after placing the conductive member in a vacuum. While measuring resistance, the conductive member was heated up to 200° C. and then, cooled to the room temperature. Resistance temperature characteristics were thereby measured together. The activation energy Ea was determined from an Arrhenius plot of the resistance temperature characteristics. The volume resistivity ρ of the conductive member was 1×10⁸ Ωcm. The activation energy Ea was 0.3 eV.

By fabricating the conductive member, a spacer was formed for an image display apparatus using surface conduction electron-emitting devices. By causing a predetermined temperature difference between the face plate and rear plate of the image display apparatus having the spacer, an image evaluation of measuring the beam movement magnitude ΔL by the influence of the spacer was performed.

When the temperature difference between the face plate and rear plate of the image display apparatus using the spacer was 8° C. or less, the beam movement magnitude ΔL was 3% or less (0.03 L or less). That is, when the temperature difference was 8° C. or less, display images were good. Further, when the temperature difference between the face plate and rear plate was 3° C. or less, the beam movement magnitude ΔL was 1% or less (0.01 L or less). That is, when the temperature difference was 3° C. or less, display images were particularly good.

### Example 2

Gold particles having the particle size of 50 μm were prepared as powder of conductive particles. Glass powder (volume resistivity=10¹⁴ Ωcm) having the particle size of 50 μm was prepared as an insulating base material. After the gold particles and glass powder was mixed so that the volume fraction of the gold particles with respect to the whole conductive member became 50 volt, the mixture was pre-sintered by heating the mixture at 800° C. Mixed powder was produced by crushing a mixed solid body obtained after the pre-sintering. By classifying the mixed powder, mixed powder called coarse particles whose particle size is 500 μm and that called fine particles whose particle size is 50 μm were obtained. The particle size ratio of coarse particles to fine particles was set to 10. Coarse particles and fine particles were compounded in the mass ratio of 7:3 and the compounded mixed powder was filled into a mold while providing vibration. A conductive member was produced by sintering the mold in an Ar gas atmosphere under pressure of 1 MPa at 800° C. The filling ratio of the conductive member was 96.

The average particle size of gold particles dispersed in the conductive member was determined by using a TEM or SEM. The average particle size of gold particles was 50 μm.

Volume resistivity of the conductive member was measured by applying the predetermined electric field (1000 V/mm) after placing the conductive member in a vacuum. While measuring resistance, the conductive member was heated up to 200° C. and then, cooled to the room temperature. Resistance temperature characteristics were thereby measured together. The activation energy Ea was determined from an Arrhenius plot of the resistance temperature characteristics. The volume resistivity ρ of the conductive member was 1×10⁵ Ωcm. The activation energy Ea was 0.2 eV.

By fabricating the conductive member, a spacer was formed for an image display apparatus using surface conduction electron-emitting devices. By causing a predetermined temperature difference between the face plate and rear plate of the image display apparatus having the spacer, an image evaluation of measuring the beam movement magnitude ΔL by the influence of the spacer was performed.

When the temperature difference between the face plate and rear plate of the image display apparatus using the spacer was 20° C. or less, no beam movement magnitude ΔL was detected. That is, when the temperature difference was 20° C. or less, display images were good.

### Example 3

Gold particles having the particle size of 1 nm were prepared as powder of conductive particles. Glass powder (volume resistivity=10¹⁴ Ωcm) having the particle size of 50 μm was prepared as an insulating base material. After the gold particles and glass powder was mixed so that the volume fraction of the gold particles with respect to the whole conductive member became 45 vol %, the mixture was pre-sintered by heating the mixture at 800° C. Mixed powder was produced by crushing a mixed solid body obtained after the pre-sintering. By classifying the mixed powder, mixed powder called coarse particles whose particle size is 500 μm and that called fine particles whose particle size is 50 μm were obtained. The particle size ratio of coarse particles to fine particles was set to 10. Coarse particles and fine particles were compounded in the mass ratio of 7:3 and the compounded mixed powder was filled into a mold while providing vibration. A conductive member was produced by sintering the mold in an Ar gas atmosphere under pressure of 2 MPa at 800° C. The filling ratio of the conductive member was 96%.

The average particle size of gold particles dispersed in the conductive member was determined by using a TEM or SEM. The average particle size of gold particles was 1 nm.

Volume resistivity of the conductive member was measured by applying the predetermined electric field (1000 V/mm) after placing the conductive member in a vacuum. While measuring resistance, the conductive member was heated up to 200° C. and then, cooled to the room temperature. Resistance temperature characteristics were thereby measured together. The activation energy Ea was determined from an Arrhenius plot of the resistance temperature characteristics. The volume resistivity ρ of the conductive member was 1×10⁸ Ωcm. The activation energy Ea was 0.2 eV.

By fabricating the conductive member, a spacer was formed for an image display apparatus using surface conduction electron-emitting devices. By causing a predetermined temperature difference between the face plate and rear plate of the image display apparatus having the spacer, an image evaluation of measuring the beam movement magnitude ΔL by the influence of the spacer was performed.

When the temperature difference between the face plate and rear plate of the image display apparatus using the spacer was 20° C. or less, no beam movement magnitude ΔL was detected. That is, when the temperature difference was 20° C. or less, display images were good.

### Comparative Example 1

Gold particles having the particle size of 0.5 nm were prepared as powder of conductive particles. Glass powder (volume resistivity=10¹⁴ Ωcm) having the particle size of 50 μm was prepared as an insulating base material. After the gold particles and glass powder was mixed so that the volume fraction of the gold particles with respect to the whole conductive member became 50 vol %, the mixture was pre-sintered by heating the mixture at 800° C. Mixed powder was produced by crushing a mixed solid body obtained after the pre-sintering. By classifying the mixed powder, mixed powder called coarse particles whose particle size is 500 μm and that called fine particles whose particle size is 50 μm were obtained. The particle size ratio of coarse particles to fine particles was set to 10. Coarse particles and fine particles were compounded in the mass ratio of 8:2 and the compounded mixed powder was filled into a mold while providing vibration. A conductive member was produced by sintering the mold in an Ar gas atmosphere under pressure of 2 MPa at 800° C. The filling ratio of the conductive member was 78%. Many voids were present in the conductive member.

The average particle size of gold particles dispersed in the conductive member was determined by using a TEM or SEM. The average particle size of gold particles was 0.5 nm.

Volume resistivity of the conductive member was measured by applying the predetermined electric field (1000 V/mm) after placing the conductive member in a vacuum. While measuring resistance, the conductive member was heated up to 200° C. and then, cooled to the room temperature. Resistance temperature characteristics were thereby measured together. The activation energy Ea was determined from an Arrhenius plot of the resistance temperature characteristics. The volume resistivity ρ of the conductive member was 1×10⁵ Ωcm. However, the activation energy Ea was 0.4 eV.

By fabricating the conductive member, a spacer was formed for an image display apparatus using surface conduction electron-emitting devices. By causing a predetermined temperature difference between the face plate and rear plate of the image display apparatus having the spacer, an image evaluation of measuring the beam movement magnitude ΔL by the influence of the spacer was performed.

When the temperature difference between the face plate and rear plate of the image display apparatus using the spacer was more than 6° C., the beam movement magnitude ΔL exceeded 3% (0.03 L or more). Thus, display images were disturbed by the influence of the spacer.

### Comparative Example 2

Gold particles having the particle size of 0.5 nm were prepared as powder of conductive particles. Glass powder (volume resistivity=10¹⁴ Ωcm) having the particle size of 50 μm was prepared as an insulating base material. After the gold particles and glass powder was mixed so that the volume fraction of the gold particles with respect to the whole conductive member became 50 vol %, the mixture was pre-sintered by heating the mixture at 800° C. Mixed powder was produced by crushing a mixed solid body obtained after the pre-sintering. By classifying the mixed powder, mixed powder called coarse particles whose particle size is 500 μm and that called fine particles whose particle size is 5 μm were obtained. The particle size ratio of coarse particles to fine particles was set to 100. Coarse particles and fine particles were compounded in the mass ratio of 7:3 and the compounded mixed powder was filled into a mold while providing vibration. A conductive member was produced by sintering the mold in an Ar gas atmosphere under pressure of 2 MPa at 800° C. The filling ratio of the conductive member was 97%.

The average particle size of gold particles dispersed in the conductive member was determined by using a TEM or SEM. The average particle size of gold particles was 0.5 nm.

Volume resistivity of the conductive member was measured by applying the predetermined electric field (1000 V/mm) after placing the conductive member in a vacuum. While measuring resistance, the conductive member was heated up to 200° C. and then, cooled to the room temperature. Resistance temperature characteristics were thereby measured together. The activation energy Ea was determined from an Arrhenius plot of the resistance temperature characteristics. The volume resistivity ρ of the conductive member was 1×10⁵ Ωcm. However, the activation energy Ea was 0.4 eV.

By fabricating the conductive member, a spacer was formed for an image display apparatus using surface conduction electron-emitting devices. By causing a predetermined temperature difference between the face plate and rear plate of the image display apparatus having the spacer, an image evaluation of measuring the beam movement magnitude ΔL by the influence of the spacer was performed.

When the temperature difference between the face plate and rear plate of the image display apparatus using the spacer was more than 6° C., the beam movement magnitude ΔL exceeded 3% (0.03 L or more). Thus, display images were disturbed by the influence of the spacer.

### Comparative Example 3

Gold particles having the particle size of 100 μm were prepared as powder of conductive particles. Glass powder (volume resistivity=10¹⁴ Ωcm) having the particle size of 50 μm was prepared as an insulating base material. After the gold particles and glass powder was mixed so that the volume fraction of the gold particles with respect to the whole conductive member became 50 vol %, the mixture was pre-sintered by heating the mixture at 800° C. Mixed powder was produced by crushing a mixed solid body obtained after the pre-sintering. By classifying the mixed powder, mixed powder called coarse particles whose particle size is 500 μm and that called fine particles whose particle size is 50 μm were obtained. The particle size ratio of coarse particles to fine particles was set to 10. Coarse particles and fine particles were compounded in the mass ratio of 7:3 and the compounded mixed powder was filled into a mold while providing vibration. A conductive member was produced by sintering the mold in an Ar gas atmosphere under pressure of 1 MPa at 800° C. The filling ratio of the conductive member was 96%.

The average particle size of gold particles dispersed in the conductive member was determined by using a TEM or SEM. The average particle size of gold particles was 100 μm.

Volume resistivity of the conductive member was measured by applying the predetermined electric field (1000 V/mm) after placing the conductive member in a vacuum. Then, a discharge occurred. This occurred because dielectric strength of the conductive member was too low. That is, the conductive member could not be used as a spacer of an image display apparatus using surface conduction electron-emitting devices.

### Comparative Example 4

Gold particles having the particle size of 0.5 nm were prepared as powder of conductive particles. Glass powder (volume resistivity=10¹⁴ Ωcm) having the particle size of 50 μm was prepared as an insulating base material. After the gold particles and glass powder was mixed so that the volume fraction of the gold particles with respect to the whole conductive member became 55 vol %, the mixture was pre-sintered by heating the mixture at 800° C. Mixed powder was produced by crushing a mixed solid body obtained after the pre-sintering. By classifying the mixed powder, mixed powder called coarse particles whose particle size is 500 μm and that called fine particles whose particle size is 50 μm were obtained. The particle size ratio of coarse particles to fine particles was set to 10. Coarse particles and fine particles were compounded in the mass ratio of 7:3 and the compounded mixed powder was filled into a mold while providing vibration. A conductive member was produced by sintering the mold in an Ar gas atmosphere under pressure of 2 MPa at 800° C. The filling ratio of the conductive member was 96%.

Volume resistivity of the conductive member was measured by applying the predetermined electric field (1000 V/mm) after placing the conductive member in a vacuum. While measuring resistance, the conductive member was heated up to 200° C. and then, cooled to the room temperature. Resistance temperature characteristics were thereby measured together. The activation energy Ea was determined from an Arrhenius plot of the resistance temperature characteristics. The volume resistivity ρ of the conductive member was 1×10³ Ωcm. The activation energy Ea was 0.2 eV.

By fabricating the conductive member, a spacer was formed for an image display apparatus using surface conduction electron-emitting devices. In an image display apparatus having the spacer, a predetermined voltage was applied between the face plate having a metal back and the rear plate having surface conduction electron-emitting devices to display images. Then, a current flowing through the spacer continued to increase. This is because of a phenomenon in which resistance of the conductive member decreases due to a temperature rise caused by electric power consumed by the spacer and the temperature continues to rise due to additional heating so that an overcurrent flows. This phenomenon is a so-called a thermal runaway.

### Example 4

Platinum particles having the particle size of 0.5 nm were prepared as powder of conductive particles. Glass powder (volume resistivity=10¹⁴ Ωcm) having the particle size of 50 μm was prepared as an insulating base material. After the platinum particles and glass powder was mixed so that the volume fraction of the platinum particles with respect to the whole conductive member became 45 vol %, the mixture was pre-sintered by heating the mixture at 1500° C. Mixed powder was produced by crushing a mixed solid body obtained after the pre-sintering. By classifying the mixed powder, mixed powder called coarse particles whose particle size is 500 μm and that called fine particles whose particle size is 50 μm were obtained. The particle size ratio of coarse particles to fine particles was set to 10. Coarse particles and fine particles were compounded in the mass ratio of 7:3 and the compounded mixed powder was filled into a mold while providing vibration. A conductive member was produced by sintering the mold in an Ar gas atmosphere under pressure of 2 MPa at 1500° C. The filling ratio of the conductive member was 96%.

The average particle size of platinum particles dispersed in the conductive member was determined by using a TEM or SEM. The average particle size of platinum particles was 0.5 nm.

Volume resistivity of the conductive member was measured by applying the predetermined electric field (1000 V/mm) after placing the conductive member in a vacuum. While measuring resistance, the conductive member was heated up to 200° C. and then, cooled to the room temperature. Resistance temperature characteristics were thereby measured together. The activation energy Ea was determined from an Arrhenius plot of the resistance temperature characteristics. The volume resistivity ρ of the conductive member was 1×10⁸ Ωcm. The activation energy Ea was 0.3 eV.

By fabricating the conductive member, a spacer was formed for an image display apparatus using surface conduction electron-emitting devices. By causing a predetermined temperature difference between the face plate and rear plate of the image display apparatus having the spacer, an image evaluation of measuring the beam movement magnitude ΔL by the influence of the spacer was performed.

When the temperature difference between the face plate and rear plate of the image display apparatus using the spacer was 8° C. or less, the beam movement magnitude ΔL was 3% or less (0.03 L or less). That is, when the temperature difference was 8° C. or less, display images were good. Further, when the temperature difference between the face plate and rear plate was 3° C. or less, the beam movement magnitude ΔL was 1% or less (0.01 L or less). That is, when the temperature difference was 3° C. or less, display images were particularly good.

### Example 5

Platinum particles having the particle size of 50 μm were prepared as powder of conductive particles. Glass powder (volume resistivity=10¹⁴ Ωcm) having the particle size of 50 μm was prepared as an insulating base material. After the platinum particles and glass powder was mixed so that the volume fraction of the platinum particles with respect to the whole conductive member became 50 vol %, the mixture was pre-sintered by heating the mixture at 1500° C. Mixed powder was produced by crushing a mixed solid body obtained after the pre-sintering. By classifying the mixed powder, mixed powder called coarse particles whose particle size is 500 μm and that called fine particles whose particle size is 50 μm were obtained. The particle size ratio of coarse particles to fine particles was set to 10. Coarse particles and fine particles were compounded in the mass ratio of 7:3 and the compounded mixed powder was filled into a mold while providing vibration. A conductive member was produced by sintering the mold in an Ar gas atmosphere under pressure of 1 MPa at 1500° C. The filling ratio of the conductive member was 96%.

The average particle size of platinum particles dispersed in the conductive member was determined by using a TEM or SEM. The average particle size of platinum particles was 50 μm.

Volume resistivity of the conductive member was measured by applying the predetermined electric field (1000 V/mm) after placing the conductive member in a vacuum. While measuring resistance, the conductive member was heated up to 200° C. and then, cooled to the room temperature. Resistance temperature characteristics were thereby measured together. The activation energy Ea was determined from an Arrhenius plot of the resistance temperature characteristics. The volume resistivity ρ of the conductive member was 1×10⁵ Ωcm. The activation energy Ea was 0.2 eV.

By fabricating the conductive member, a spacer was formed for an image display apparatus using surface conduction electron-emitting devices. By causing a predetermined temperature difference between the face plate and rear plate of the image display apparatus having the spacer, an image evaluation of measuring the beam movement magnitude ΔL by the influence of the spacer was performed.

When the temperature difference between the face plate and rear plate of the image display apparatus using the spacer was 20° C. or less, no beam movement magnitude ΔL was detected. That is, when the temperature difference was 20° C. or less, display images were good.

### Example 6

Silver particles having the particle size of 0.5 nm were prepared as powder of conductive particles. Glass powder (volume resistivity=10¹⁴ Ωcm) having the particle size of 50 μm was prepared as an insulating base material. After the silver particles and glass powder was mixed so that the volume fraction of the silver particles with respect to the whole conductive member became 45 volt, the mixture was pre-sintered by heating the mixture at 800° C. Mixed powder was produced by crushing a mixed solid body obtained after the pre-sintering. By classifying the mixed powder, mixed powder called coarse particles whose particle size is 500 μm and that called fine particles whose particle size is 50 μm were obtained. The particle size ratio of coarse particles to fine particles was set to 10. Coarse particles and fine particles were compounded in the mass ratio of 7:3 and the compounded mixed powder was filled into a mold while providing vibration. A conductive member was produced by sintering the mold in an Ar gas atmosphere under pressure of 2 MPa at 800° C. The filling ratio of the conductive member was 96%.

The average particle size of silver particles dispersed in the conductive member was determined by using a TEM or SEM. The average particle size of silver particles was 0.5 nm.

Volume resistivity of the conductive member was measured by applying the predetermined electric field (1000 V/mm) after placing the conductive member in a vacuum. While measuring resistance, the conductive member was heated up to 200° C. and then, cooled to the room temperature. Resistance temperature characteristics were thereby measured together. The activation energy Ea was determined from an Arrhenius plot of the resistance temperature characteristics. The volume resistivity ρ of the conductive member was 1×10⁸ Ωcm. The activation energy Ea was 0.3 eV.

By fabricating the conductive member, a spacer was formed for an image display apparatus using surface conduction electron-emitting devices. By causing a predetermined temperature difference between the face plate and rear plate of the image display apparatus having the spacer, an image evaluation of measuring the beam movement magnitude ΔL by the influence of the spacer was performed.

When the temperature difference between the face plate and rear plate of the image display apparatus using the spacer was 8° C. or less, the beam movement magnitude ΔL was 3% or less (0.03 L or less). That is, when the temperature difference was 8° C. or less, display images were good. Further, when the temperature difference between the face plate and rear plate was 3° C. or less, the beam movement magnitude ΔL was 1% or less (0.01 L or less). That is, when the temperature difference was 3° C. or less, display images were particularly good.

### Example 7

Silver particles having the particle size of 50 μm were prepared as powder of conductive particles. Glass powder (volume resistivity=10¹⁴ Ωcm) having the particle size of 50 μm was prepared as an insulating base material. After the silver particles and glass powder was mixed so that the volume fraction of the silver particles with respect to the whole conductive member became 50 volt, the mixture was pre-sintered by heating the mixture at 800° C. Mixed powder was produced by crushing a mixed solid body obtained after the pre-sintering. By classifying the mixed powder, mixed powder called coarse particles whose particle size is 500 μm and that called fine particles whose particle size is 50 μm were obtained. The particle size ratio of coarse particles to fine particles was set to 10. Coarse particles and fine particles were compounded in the mass ratio of 7:3 and the compounded mixed powder was filled into a mold while providing vibration. A conductive member was produced by sintering the mold in an Ar gas atmosphere under pressure of 1 MPa at 800° C. The filling ratio of the conductive member was 96%.

The average particle size of silver particles dispersed in the conductive member was determined by using a TEM or SEM. The average particle size of silver particles was 50 μm.

Volume resistivity of the conductive member was measured by applying the predetermined electric field (1000 V/mm) after placing the conductive member in a vacuum. While measuring resistance, the conductive member was heated up to 200° C. and then, cooled to the room temperature. Resistance temperature characteristics were thereby measured together. The activation energy Ea was determined from an Arrhenius plot of the resistance temperature characteristics. The volume resistivity ρ of the conductive member was 1×10⁵ Ωcm. The activation energy Ea was 0.2 eV.

By fabricating the conductive member, a spacer was formed for an image display apparatus using surface conduction electron-emitting devices. By causing a predetermined temperature difference between the face plate and rear plate of the image display apparatus having the spacer, an image evaluation of measuring the beam movement magnitude ΔL by the influence of the spacer was performed. When the temperature difference between the face plate and rear plate of the image display apparatus using the spacer was 20° C. or less, no beam movement magnitude ΔL was detected. That is, when the temperature difference was 20° C. or less, display images were good.

### Example 8

Gold particles having the particle size of 50 μm were prepared as powder of conductive particles. Glass powder (volume resistivity=10⁶ Ωcm) having the particle size of 50 μm was prepared as an insulating base material. After the gold particles and glass powder was mixed so that the volume fraction of the gold particles with respect to the whole conductive member became 50 vol %, the mixture was pre-sintered by heating the mixture at 800° C. Mixed powder was produced by crushing a mixed solid body obtained after the pre-sintering. By classifying the mixed powder, mixed powder called coarse particles whose particle size is 500 μm and that called fine particles whose particle size is 50 μm were obtained. The particle size ratio of coarse particles to fine particles was set to 10. Coarse particles and fine particles were compounded in the mass ratio of 7:3 and the compounded mixed powder was filled into a forming die while providing vibration. A conductive member was produced by sintering the forming die in an Ar gas atmosphere under pressure of 1 MPa at 800° C. The filling ratio of the conductive member was 96%.

The average particle size of gold particles dispersed in the conductive member was determined by using a TEM or SEM. The average particle size of gold particles was 50 μm.

Volume resistivity of the conductive member was measured by applying the predetermined electric field (1000 V/mm) after placing the conductive member in a vacuum. While measuring resistance, the conductive member was heated up to 200° C. and then, cooled to the room temperature. Resistance temperature characteristics were thereby measured together. The activation energy Ea was determined from an Arrhenius plot of the resistance temperature characteristics. The volume resistivity ρ of the conductive member was 1×10⁵ Ωcm. The activation energy Ea was 0.2 eV.

By fabricating the conductive member, a spacer was formed for an image display apparatus using surface conduction electron-emitting devices. By causing a predetermined temperature difference between the face plate and rear plate of the image display apparatus having the spacer, an image evaluation of measuring the beam movement magnitude ΔL by the influence of the spacer was performed.

When the temperature difference between the face plate and rear plate of the image display apparatus using the spacer was 20° C. or less, no beam movement magnitude ΔL was detected. That is, when the temperature difference was 20° C. or less, display images were good. In each of the above examples, the material, size or the like may be changed when appropriate. For example, in each of the above examples, glass whose volume resistivity is 10¹⁴ Ωcm is used as an insulating base material. However, the insulating base material is not limited to this. Any insulating base material may be used when volume resistivity of the spacer is equal to 10⁵ Ωcm or more. Because an insulating base material is combined with conductive particles, the insulating base material may be appropriately selected from insulating materials.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-112533, filed on Apr. 23, 2007, which is hereby incorporated by reference herein in its entirety.

This application claims the benefit of Japanese Patent Application No. 2008-095107, filed on Apr. 1, 2008, which is hereby incorporated by reference herein in its entirety.

1. A conductive member comprising:
a base material; and
conductive particles whose conductivity is larger than that of the base material dispersed in the base material, wherein
the conductive particles are dispersed in the base material in such a way that activation energy of the conductive member is 0.3 eV or less and volume resistivity of the conductive member is 10⁵ Ωcm or more.

2. A conductive member according to claim 1, wherein
the conductive particles are dispersed in the base material in such a way that the activation energy of the conductive member is 0.2 eV or less.

3. A conductive member according to claim 1, wherein
the conductive particles are dispersed in the base material in such a way that the volume resistivity of the conductive member is 10⁸ Ωcm or more.

4. A conductive member according to claim 1, wherein
a particle diameter of the conductive particles is not less than 0.5 nm and not more than 50 μm.

5. A conductive member according to claim 1, wherein
a volume fraction of the conductive particles with respect to the whole conductive member is 50 vol % or less.

6. A conductive member according claim 1, wherein
the conductive particles are formed of at least one metal selected from gold, platinum, silver, palladium, ruthenium, rhodium, osmium, and iridium.

7. A spacer
arranged between a first substrate and a second substrate in an image display apparatus comprising an airtight vessel having the first substrate having an electron source and the second substrate having an image display member opposite to the electron source, wherein the spacer is the conductive member in claim 1.

8. An image display apparatus comprising:
an airtight vessel having a first substrate having an electron source and a second substrate having an image display member opposite to the electron source; and
a spacer arranged between the first substrate and the second substrate, wherein
the spacer is the conductive member in claim 1.
